(19) United States
(12) Patent Application Publication
(10) Pub. No.: US 2017/0082151 A1
(43) Pub. Date: Mar. 23, 2017

(54) Drive Universal Joint with Anti-jamming design

(71) Applicant: Hong Ann Tool Industries Co., Ltd., Taichung City (TW)

(72) Inventor: Cheng-Wei Su, Taichung City (TW)

(21) Appl. No.: 14/858,884

(22) Filed: Sep. 18, 2015

(51) Int. Cl. F16D 3/18

(52) U.S. Cl. CPC F16D 3/20

(57) ABSTRACT

A drive universal joint includes first and second drive joint members coupled together. The first drive joint member includes a joining end defining a compartment with an inner peripheral wall thereof including six edges. Each of the edges defines a convex contour. Each of the edges has an anti jamming design. The anti-jamming design defines a recess extending radially into an apex region of the edge. The second drive joint member includes a joining end defines a body. The body is enclosed by the six edges. The body includes an outer peripheral wall thereof including six sides. Each of the sides defines a convex contour. The drive universal joint includes one of the sides constrained to face one of the first edges and includes the anti-jamming design on each of the first edges avoiding physical contact with each of sides.

### BACKGROUND OF THE INVENTION

### 1. Field of the Invention

The present invention relates to a drive universal joint and, particularly, to a drive universal joint with anti jamming design.

### 2. Description of the Related Art

TW Pat. No. M357344, entitled a two-stage tool joint, teaches a tool joint including a supporting rod having a polygonal spherical head at an end, a working head having a receiving compartment at an end, and a retainer disposed between the supporting rod and the working head to retrain the polygonal spherical head in the receiving compartment. The receiving compartment has a lateral wall defining a plurality of convex edges and a plurality of concave edges. The pluralities of convex and concaves edges are disposed alternatively. Each of sides of the polygonal spherical head corresponds to and abuts one of the convex edges of the receiving compartment. The supporting rod is operably pivotal relative to the working head. It is known that the tool joint can be used to drive a screw, a bolt, or a fastener. The tool joint can be manually or automatically driven by engaging the working head with a power tool, and the supporting rod can couple to a specific driving tool to engage with an object to be driven. However, the supporting rod is likely to get stuck in the working head if high torque is transmitted through the tool joint. Therefore, the supporting rod is unable to be operably pivoted relative to the working head.

FIG. 1 is a cross-sectional view showing a tool joint similar to that of TW Pat. No. M357344 and illustrating a supporting rod 90 jammed in a working head 91 after the tool joint is subject to high torque, which results deformations of an outer periphery of the supporting rod, as shown in the figure.

The present invention is, therefore, intended to obviate or at least alleviate the problems encountered in the prior art.

### SUMMARY OF THE INVENTION

According to the present invention, a drive universal joint with anti jamming design includes a first drive joint member and a second drive joint member coupled together. The first drive joint member has a longitudinal length extending along a first phantom axis, which extends on a center of the first drive joint member. The first drive joint member includes a first joining end and a second joining end at different ends. The second joining end defines a compartment. The compartment has an inner peripheral wall thereof including six first edges. Each of the first edges defines a convex contour extending transversely to the longitudinal length of the first drive joint member. Each of the first edges has an anti jamming design. The anti-jamming design defines a recess extending radially into an apex region of the first edge. The second drive joint member has a longitudinal length extending along a second phantom axis, which extends on a center of the second drive joint member. The second drive joint member includes a third joining end and a fourth joining end at different ends. The third joining end defines a body. The body is enclosed by the six first edges. The body includes an outer peripheral wall thereof including six sides. Each of the sides defines a convex contour extending along the longitudinal length of the second drive joint member. The fourth joining end protrudes outside the compartment of the second joining end. The combination of the first and second drive joint members includes one of the sides constrained to face one of the first edges and includes the anti-jamming design on each of the first edges avoiding physical contact with each of sides.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a cross-sectional view showing a conventional tool joint.

FIG. 2 is a perspective view of a drive universal joint in accordance with a first embodiment of the present invention.

FIG. 3 is an exploded perspective view of the drive universal joint of the first embodiment.

FIG. 4 is a cross-sectional view of the drive universal joint of the first embodiment.

FIG. 5 is a cross-sectional view taken along line 5-5 of FIG. 4.

FIG. 6 is an exploded perspective view of a drive universal joint in accordance with a second embodiment of the present invention.

FIG. 7 is a cross-sectional view of the drive universal joint of the second embodiment.

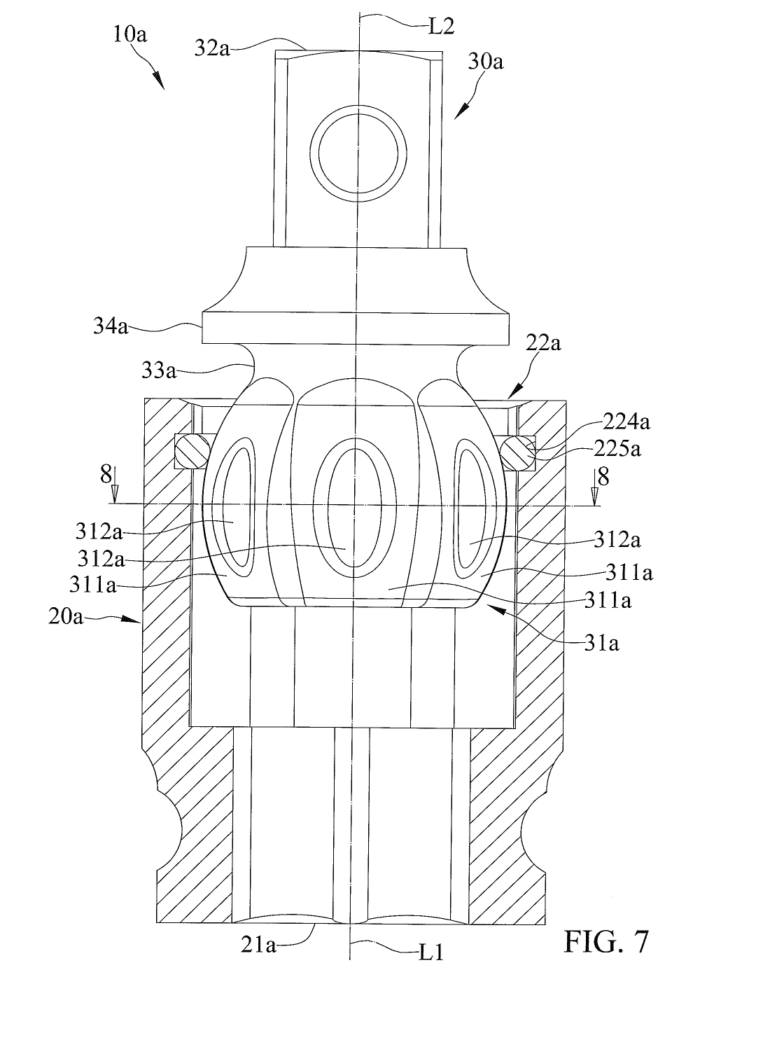

FIG. 8 is a cross-sectional view taken along line 8-8 of FIG. 7.

### DETAILED DESCRIPTION OF THE INVENTION

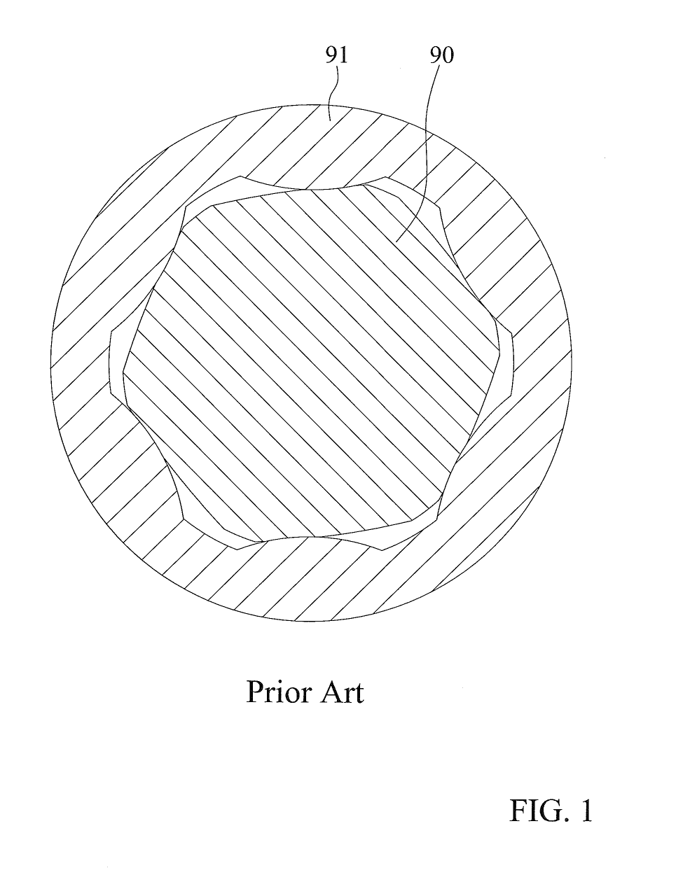

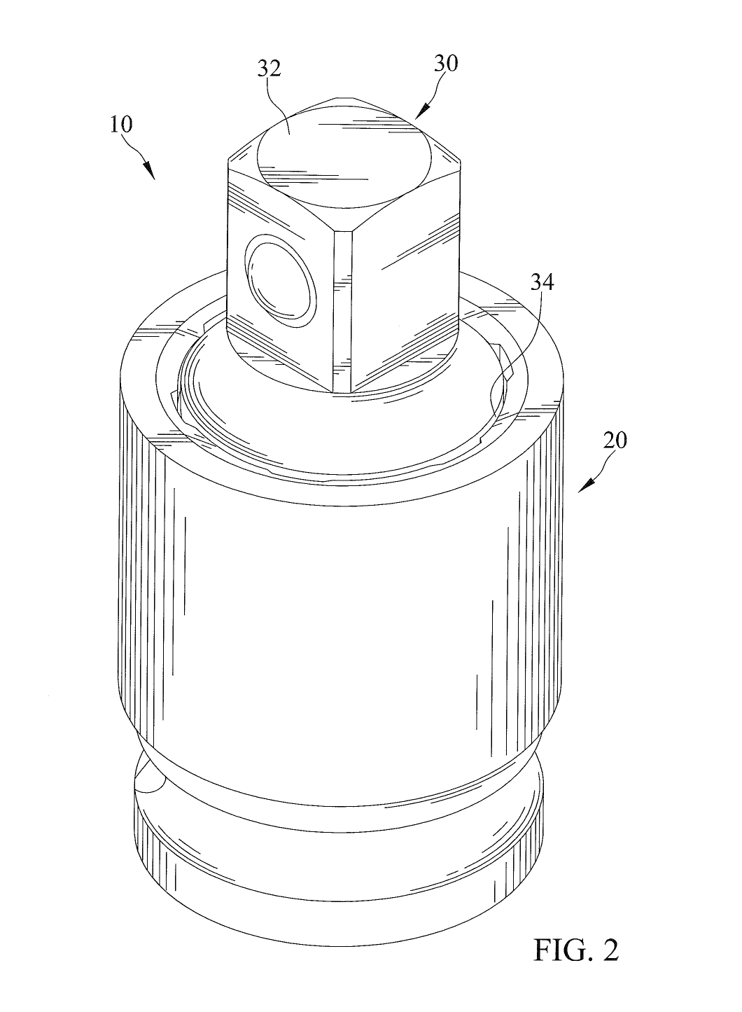

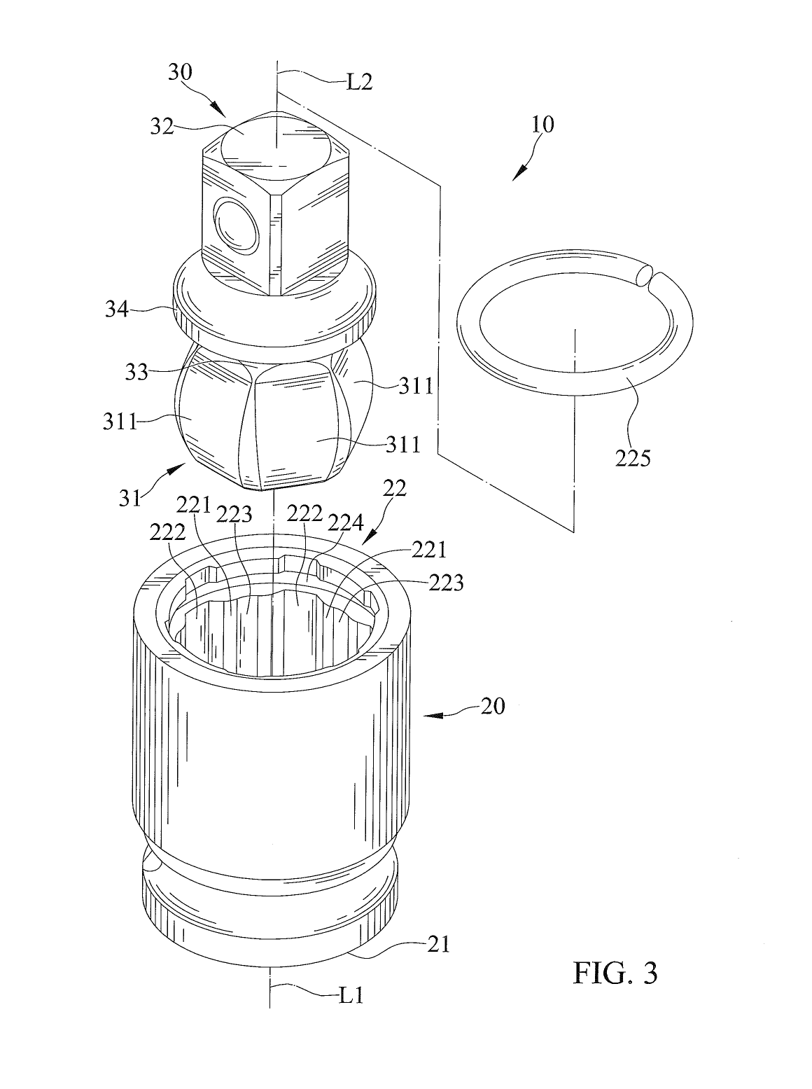

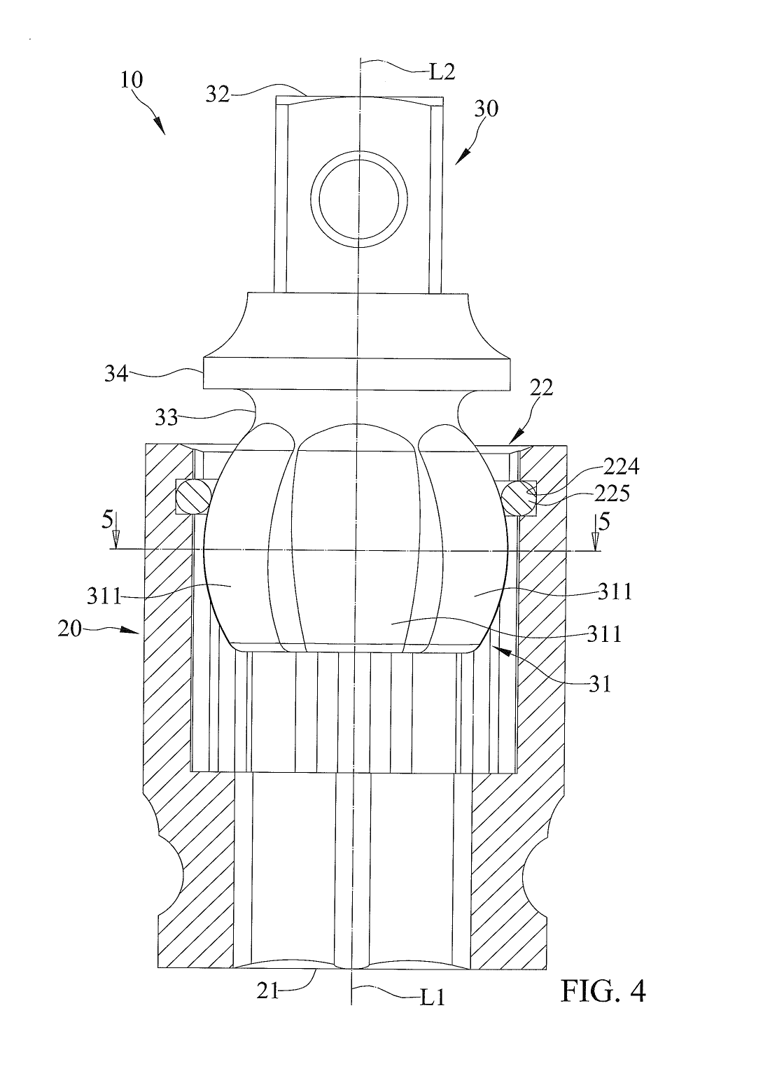

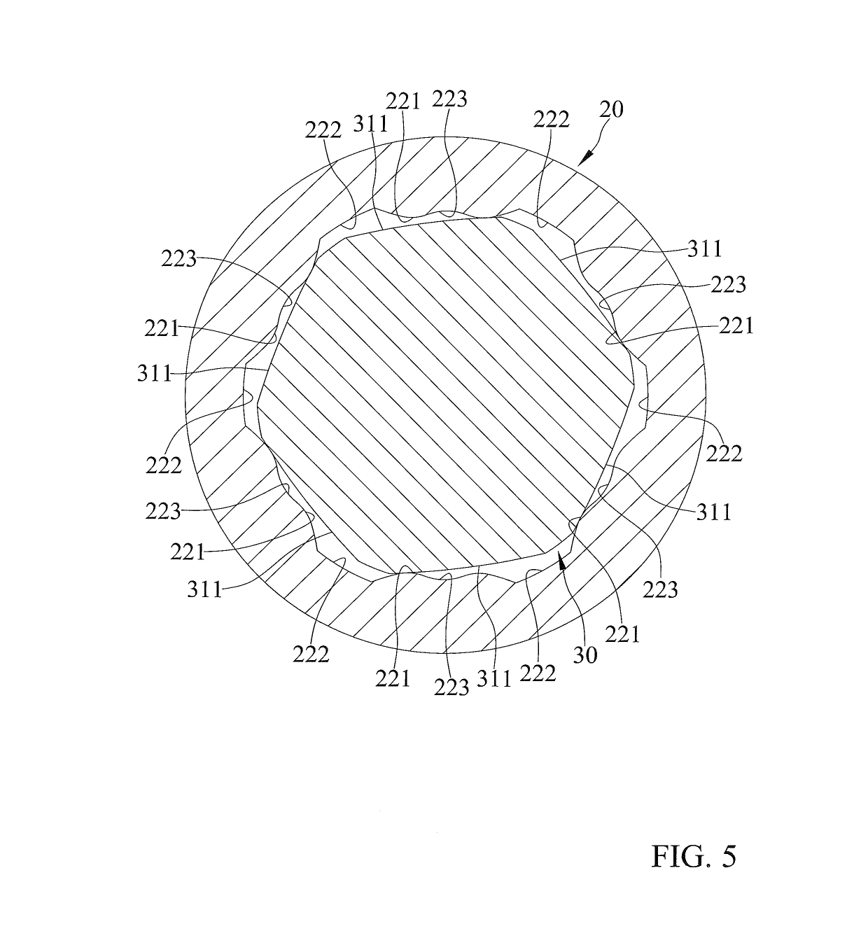

FIGS. 1 through 5 show a drive universal joint 10 in accordance with a first embodiment of the present invention. The drive universal joint 10 includes a first drive joint member 20 and a second drive joint member 30 coupled together.

The first drive joint member 20 has a longitudinal length extending along a first phantom axis L1, which extends on a center of the first drive joint member 20. The first drive joint member 20 includes a first joining end 21 and a second joining end 22 at different ends. The second joining end 22 defines a compartment. The compartment has an inner peripheral wall thereof including six first edges 221. Each of the first edges 221 defines a convex contour extending transversely to the longitudinal length of the first drive joint member 20. Each of the six first edges 221 extends longitudinally along the longitudinal length of the first drive joint member 20. Each of the first edges 221 has an anti jamming design 223. The anti jamming design 223 defines a recess extending radially into an apex region of the first edge 221. The apex region of the first edge 221 refers to the thickest region of the first edge 221. The anti jamming design 223 on each of the first edges 221 defines a concave contour extending transversely to the longitudinal length of the first drive joint member 20. The anti-jamming design 223 on each of the first edges 221 defines an elongated recessed area extending along the longitudinal length of the first drive joint member 20. The inner wall of the compartment further defines second edges 222. The first and second edges 221 and 222 are alternatively disposed circumferentially on the inner wall of the compartment. Each of the second edges 222 defines a recessed area, which has a depth increasing in a radially outward direction towards an outer peripheral wall of the first drive joint member 20.

The second drive joint member 30 has a longitudinal length extending along a second phantom axis L2, which extends on a center of the second drive joint member 30. The second drive joint member 30 includes a third joining end 31 and a fourth joining end 32 at different ends. The third joining end 31 defines a body. The body is enclosed by the six first edges 221. The body includes an outer peripheral wall thereof including six sides 311. Each of the sides 311 defines a convex contour extending along the longitudinal length of the second drive joint member 30. The fourth joining end 32 protrudes outside the compartment of the second joining end 22. The fourth joining end 32 is adapted to couple to a specific driving tool which is used to drive an object. The fourth joining end 32 has a main body for engaging with the specific driving tool. The main body is of a quadrilateral shape, but not limited thereto. The main body of the fourth joining end 32 includes a detent to restrain the specific driving tool. This detent is radially movable. The detent is of a spherical shape, but not limited thereto. The second drive joint member 30 defines a neck 33 extending between the third and fourth joining ends 31 and 32. The second drive joint member 30 has diameters decreasing from the apex of each of the sides 311 to the neck 33. The apex of each of the sides 311 has a first diameter, which extends transversely to the second phantom axis L2. The neck 33 has a second diameter, which is the smallest and which extends transversely to the second phantom axis L2. The first diameter is greater than the second diameter. The second drive joint member 30 defines a flange 34 extending between the fourth joining end 32 and the neck 33. The second drive joint member 30 has diameters increasing from the neck 33 to the flange 34. The flange 34 has a third diameter, which is the largest and which extends transversely to the second phantom axis L2. The third diameter is greater than the second diameter.

The combination of the first and second drive joint members 20 and 30 includes one of the sides 311 constrained to face one of the first edges 221 and includes the anti-jamming design 223 on each of the first edges 221 avoiding physical contact with each of sides 311 as well as the second edges 222 avoiding physical contacts with the outer peripheral wall of the second drive joint member 30. The second joining end 22 and the third joining end 31 are configured such that the first drive joint member 20 is operably pivotal relative to the second drive joint member 30. Moreover, with the anti-jamming design 223 on each of the first edges 221, the third joining end 31 is prevented from getting stuck in the second joining end 22 if high torque is transmitted through the drive universal joint 10.

Furthermore, a groove 224 extends circumferentially on the inner wall of the compartment and has a depth increasing in the radially outward direction towards the outer peripheral wall of the first drive joint member 20. The groove 224 receives an annular retainer 225 for preventing the body of the third joining end 31 from moving out of the compartment of the second joining end 22. The retainer 225 protrudes out of the groove 224 and applies radial forces on the body of the third joining end 31. The retainer 225 abuts and surrounds the third joining end 31 between the apex of each of the sides 311 and the neck 33. The retainer 225 is a C-ring. The retainer 225 is resilient.

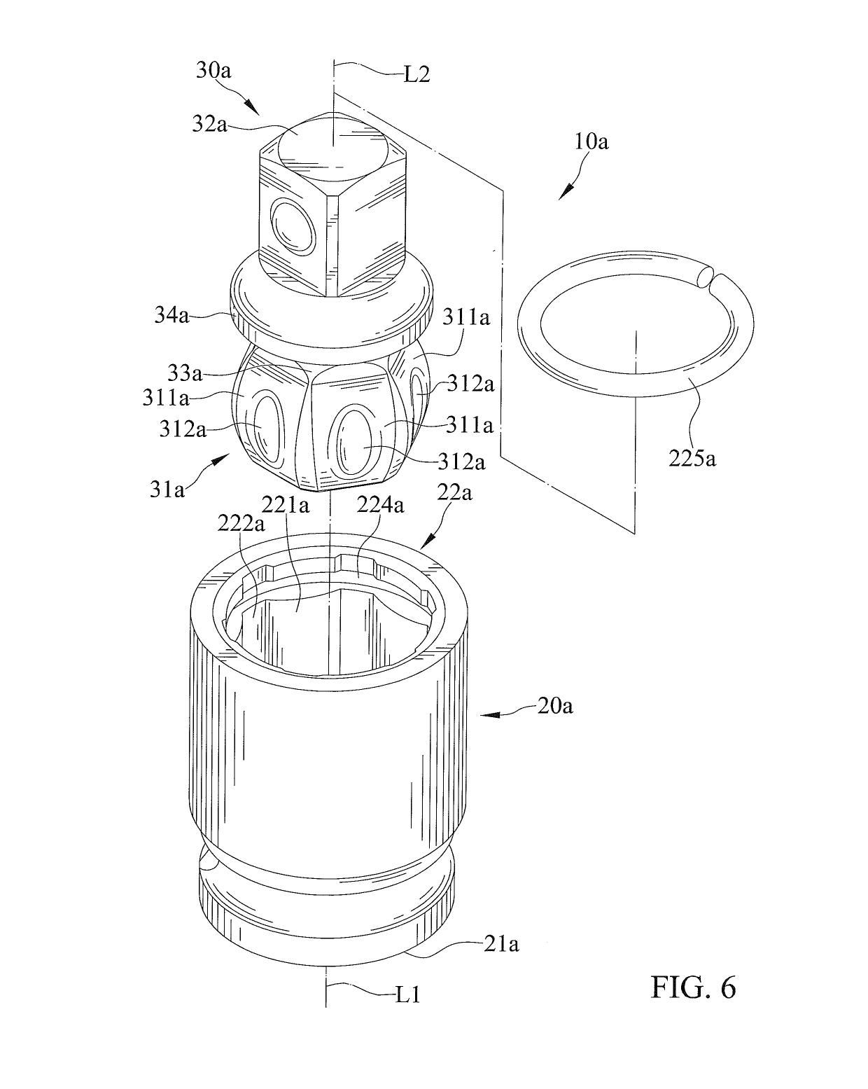

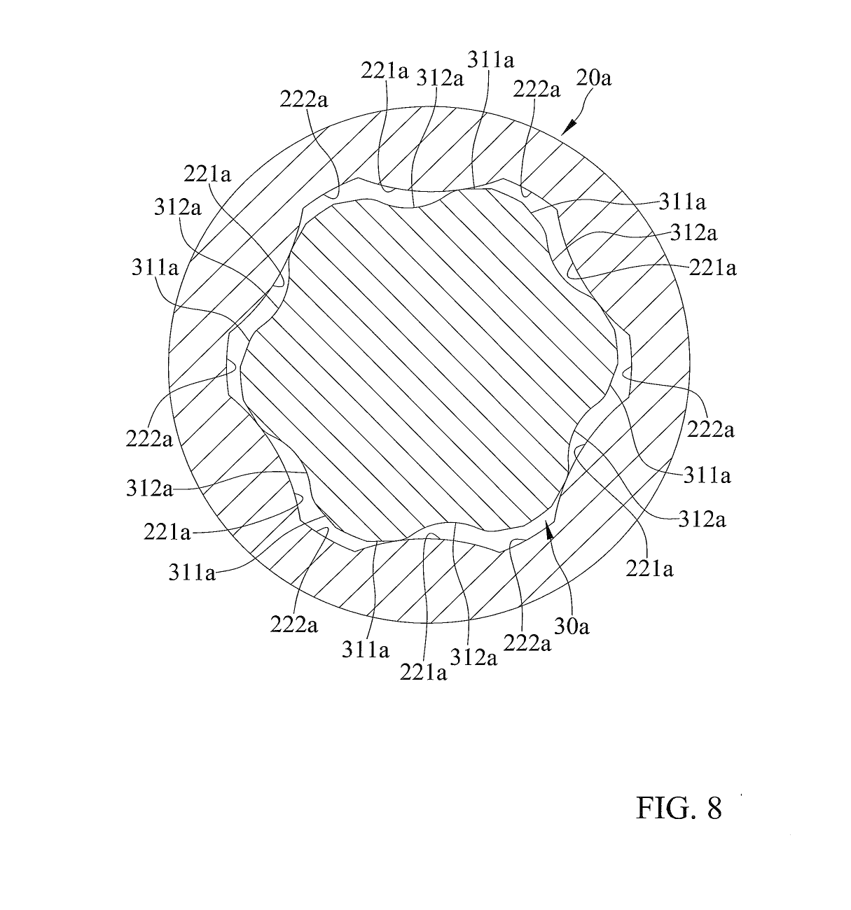

FIGS. 6 and 8 show a tool 10a shows a drive universal joint 10a in accordance with a second embodiment of the present invention. The drive universal joint 10a includes a first drive joint member 20a and a second drive joint member 30a coupled together.

The first drive joint member 20a has a longitudinal length extending along a first phantom axis L1, which extends on a center of the first drive joint member 20a. The first drive joint member 20a includes a first joining end 21a and a second joining end 22a at different ends. The second joining end 22a defines a compartment. The compartment has an inner peripheral wall thereof including six first edges 221a. Each of the first edges 221a defines a convex contour extending transversely to the longitudinal length of the first drive joint member 20a. The inner wall of the compartment further defines second edges 222a. The first and second edges 221a and 222a are alternatively disposed circumferentially on the inner wall of the compartment. Each of the second edges 222a defines a recessed area, which has a depth increasing in a radially outward direction towards an outer peripheral wall of the first drive joint member 20a.

The second drive joint member 30a has a longitudinal length extending along a second phantom axis L2, which extends on a center of the second drive joint member 30a. The second drive joint member 30a includes a third joining end 31a and a fourth joining end 32a at different ends. The third joining end 31a defines a body. The body is enclosed by the six first edges 221a. The body includes an outer peripheral wall thereof including six sides 311a. Each of the sides 311a defines a convex contour extending along the longitudinal length of the second drive joint member 30a. Each of the sides 311a has an anti jamming design 312a. The anti jamming design 312a defines a recess extending radially into an apex region of the side 311a. The apex region of the sides 311 refers to the thickest region of sides 311. The anti jamming design 312a on each of the sides 311a defines a concave contour extending transversely to the longitudinal length of the second drive joint member 30a. The fourth joining end 32a protrudes outside the compartment of the second joining end 22a. The fourth joining end 32a is adapted to couple to a specific driving tool which is used to drive an object. The fourth joining end 32a has a main body for engaging with the specific driving tool. The main body is of a quadrilateral shape, but not limited thereto. The main body of the fourth joining end 32 includes a detent to restrain the specific driving tool. This detent is radially movable. The detent is of a spherical shape, but not limited thereto. The second drive joint member 30a defines a neck 33a extending between the third and fourth joining ends 31a and 32a. The second drive joint member 30a has diameters decreasing from the apex of each of the sides 311a to the neck 33a. The retainer 225a abuts and surrounds the third joining end 31a between the apex of each of the sides 311a and the neck 33a. The apex of each of the sides 311 has a first diameter, which extends transversely to the second phantom axis L2. The neck 33 has a second diameter, which is the smallest and which extends transversely to the second phantom axis L2. The first diameter is greater than the second diameter. The second drive joint member 30a defines a flange 34a extending between the fourth joining end 32a and the neck 33a. The second drive joint member 30a has diameters increasing from the neck 33a to the flange 34a. The flange 34a has a third diameter, which is the largest and which extends transversely to the second phantom axis L2. The third diameter is greater than the second diameter.

The combination of the first and second drive joint members 20a and 30a includes one of the sides 311a constrained to face one of the first edges 221a and includes the anti jamming design 312a on each of the sides 311 avoiding physical contact with each of the first edges 221a as well as the second edges 222a avoiding physical contacts with the outer peripheral wall of the second drive joint member 30a. The second joining end 22a and the third joining end 31a are configured such that the first drive joint member 20a is operably pivotal relative to the second drive joint member 30a. Moreover, with the anti jamming design 312a on each of the sides 311a, the third joining end 31a is prevented from getting stuck in the second joining end 22a if high torque is transmitted through the drive universal joint 10a.

Furthermore, a groove 224a extends circumferentially on the inner wall of the compartment and has a depth increasing in the radially outward direction towards the outer peripheral wall of the first drive joint member 20a. The groove 224a receives an annular retainer 225a for preventing the body of the third joining end 31a from moving out of the compartment of the second joining end 22a. The retainer 225a protrudes out of the groove 224a and applies radial forces on the body of the third joining end 31a. The retainer 225 is a C-ring. The retainer 225 is resilient.

In view of the forgoing, the first drive joint member 20 is operably pivotal relative to the second drive joint member 30. Moreover, with the anti-jamming design 223 on each of the first edges 221, the third joining end 31 is prevented from getting stuck in the second joining end 22 if high torque is transmitted through the drive universal joint 10. Likewise, the first and drive joint member 20a is operably pivotal relative to the second drive joint member 30a. Moreover, with the anti jamming design 312a on each of the sides 311a, third joining end 31a is prevented from getting stuck in the second joining end 22a if high torque is transmitted through the drive universal joint 10a.

The foregoing is merely illustrative of the principles of this invention and various modifications can be made by those skilled in the art without departing from the scope and spirit of the invention.

What is claimed is:

1. A drive universal joint with anti-jamming design comprising:
a first drive joint member having a longitudinal length extending along a first phantom axis, which extends on a center of the first drive joint member, and including a first joining end and a second joining end at different ends, wherein the second joining end defines a compartment, with the compartment having an inner peripheral wall thereof including six first edges, with each of the first edges defining a convex contour extending transversely to the longitudinal length of the first drive joint member, with each of the first edges having an anti jamming design, and with the anti jamming design defining a recess extending radially into an apex region of the first edge; and
a second drive joint member having a longitudinal length extending along a second phantom axis, which extends on a center of the second drive joint member, and including a third joining end and a fourth joining end at different ends, wherein the third joining end defines a body, with the body enclosed by the six first edges, with the body including an outer peripheral wall thereof including six sides, with each of the sides defining a convex contour extending along the longitudinal length of the second drive joint member, and wherein the fourth joining end protrudes outside the compartment of the second joining end;
wherein the first and second drive joint members are coupled together, with one of the sides constrained to face one of the first edges, with the anti jamming design on each of the first edges avoiding physical contact with each of sides.

2. The drive universal joint as claimed in claim 1, wherein the anti jamming design on each of the first edges defines a concave contour extending transversely to the longitudinal length of the first drive joint member, and wherein the anti jamming design on each of the first edges defines an elongated recessed area extending along the longitudinal length of the first drive joint member.

3. The drive universal joint as claimed in claim 1, wherein the inner wall of the compartment further defines second edges, wherein the first and second edges are alternatively disposed circumferentially on the inner wall of the compartment, wherein each of the second edges defines a recessed area, which has a depth increasing in a radially outward direction towards an outer peripheral wall of the first drive joint member, and wherein the second edges avoid physical contacts with the outer peripheral wall of the second drive joint member.

4. The drive universal joint as claimed in claim 2, wherein the inner wall of the compartment further defines second edges, wherein the first and second edges are alternatively disposed circumferentially on the inner wall of the compartment, wherein each of the second edges defines a recessed area, which has a depth increasing in a radially outward direction towards an outer peripheral wall of the first drive joint member, and wherein the second edges avoid physical contacts with the outer peripheral wall of the second drive joint member.

5. The drive universal joint as claimed in claim 3 further comprising a groove extending circumferentially on the inner wall of the compartment and having a depth increasing in the radially outward direction towards the outer peripheral wall of the first drive joint member, wherein the groove receives an annular retainer for preventing the body of the third joining end from moving out of the compartment of the second joining end, with the retainer protruding out of the groove and applying radial forces on the body of the third joining end.

6. The drive universal joint as claimed in claim 4 further comprising a groove extending circumferentially on the inner wall of the compartment and having a depth increasing in the radially outward direction towards the outer peripheral wall of the first drive joint member, wherein the groove receives an annular retainer for preventing the body of the third joining end from moving out of the compartment of the second joining end, with the retainer protruding out of the groove and applying radial forces on the body of the third joining end.

7. The drive universal joint as claimed in claim 6, wherein the second drive joint member defines a neck extending between the third and fourth joining ends, wherein the second drive joint member has diameters decreasing from the apex of each of the sides to the neck, and wherein the retainer abuts and surrounds the third joining end between the apex of each of the sides and the neck.

8. The drive universal joint as claimed in claim 7 herein the second drive joint member defines a flange extending between the fourth joining end and the neck, and wherein the second drive joint member has diameters increasing from the neck to the flange.

9. A drive universal joint with anti jamming design comprising:
a first drive joint member having a longitudinal length extending along a first phantom axis, which extends on a center of the first drive joint member, and including a first joining end and a second joining end at different ends, wherein the second joining end defines a compartment, with the compartment having an inner peripheral wall thereof including six first edges, and with each of the first edges defining a convex contour extending transversely to the longitudinal length of the first drive joint member; and
a second drive joint member having a longitudinal length extending along a second phantom axis, which extends on a center of the second drive joint member, and including a third joining end and a fourth joining end at different ends, wherein the third joining end defines a body, with the body enclosed by the six first edges, with the body including an outer peripheral wall thereof including six sides, with each of the sides defining a convex contour extending along the longitudinal length of the second drive joint member, with each of the sides having an anti jamming design, with the anti jamming design defining a recess extending radially into an apex region of the side, and wherein the fourth joining end protrudes outside the compartment of the second joining end;
wherein the first and second drive joint members are coupled together, with one of the sides constrained to face one of the first edges, and with the anti-jamming design on each of the sides avoiding physical contact with each of the first edges.

10. The drive universal joint as claimed in claim 9, wherein the anti jamming design on each of the sides defines a concave contour extending transversely to the longitudinal length of the second drive joint member.

11. The drive universal joint as claimed in claim 9, wherein the inner wall of the compartment further defines second edges, wherein the first and second edges are alternatively disposed circumferentially on the inner wall of the compartment, wherein each of the second edges defines a recessed area, which has a depth increasing in a radially outward direction towards an outer peripheral wall of the first drive joint member, and wherein the second edges avoid physical contacts with the outer peripheral wall of the second drive joint member.

12. The drive universal joint as claimed in claim 10, wherein the inner wall of the compartment further defines second edges, wherein the first and second edges are alternatively disposed circumferentially on the inner wall of the compartment, wherein each of the second edges defines a recessed area, which has a depth increasing in a radially outward direction towards an outer peripheral wall of the first drive joint member, and wherein the second edges avoid physical contacts with the outer peripheral wall of the second drive joint member.

13. The drive universal joint as claimed in claim 11 further comprising a groove extending circumferentially on the inner wall of the compartment and having a depth increasing in the radially outward direction towards the outer peripheral wall of the first drive joint member, wherein the groove receives an annular retainer for preventing the body of the third joining end from moving out of the compartment of the second joining end, with the retainer protruding out of the groove and applying radial forces on the body of the third joining end.

14. The drive universal joint as claimed in claim 12 further comprising a groove extending circumferentially on the inner wall of the compartment and having a depth increasing in the radially outward direction towards the outer peripheral wall of the first drive joint member, wherein the groove receives an annular retainer for preventing the body of the third joining end from moving out of the compartment of the second joining end, with the retainer protruding out of the groove and applying radial forces on the body of the third joining end.

15. The drive universal joint as claimed in claim 14, wherein the second drive joint member defines a neck extending between the third and fourth joining ends, wherein the second drive joint member has diameters decreasing from the apex of each of the sides to the neck, and wherein the retainer abuts and surrounds the third joining end between the apex of each of the sides and the neck.

16. The drive universal joint as claimed in claim 15 herein the second drive joint member defines a flange extending between the fourth joining end and the neck, and wherein the second drive joint member has diameters increasing from the neck to the flange.
